(19) United States
(12) Patent Application Publication
(10) Pub. No.: US 2016/0231718 A1
(43) Pub. Date: Aug. 11, 2016

(54) Personal Proximity with Preferences

(71) Applicant: Twin Harbor Labs, LLC, Plano, TX (US)

(72) Inventors: James D Logan, Candia, NH (US); Scott Durgin, North Andover, MA (US); Richard A Baker, JR., West Newbury, MA (US)

(73) Assignee: Twin Harbor Labs, LLC, Plano, TX (US)

(21) Appl. No.: 15/017,796

(22) Filed: Feb. 8, 2016

Related U.S. Application Data
(60) Provisional application No. 62/113,589, filed on Feb. 9, 2015.

(51) Int. Cl. G05B 15/02

(52) U.S. Cl. CPC G05B 15/02

(57) ABSTRACT

A scheme for coordinating the preferences of multiple intelligent devices into the setting of parameters for devices and users is described. This coordination involves the negotiation of preferences between multiple devices within a context using one of more of a multiplicity of negotiating techniques.

### RELATED APPLICATIONS

This patent application is a non-provisional application of, and claims the benefit of the filing dates of, U.S. Provisional Patent No. 62/113,589 filed on Feb. 9, 2015 entitled Intelligent Cooking Apparatuses and Methods. The disclosures of this provisional patent application is incorporated herein by reference.

### BACKGROUND OF INVENTION

1. Field of the Invention

The present invention is directed to communications between mobile and other intelligent devices, and more specifically to the transmission and implementation of preferences between mobile devices and other devices.

2. Description of the Related Art

Since the beginning of time, man has been communicating his preferences regarding the environment around him. At first, man complained that the winters were too cold and that the summers were too hot. But the environment did not change when he complained. Until later, when man discovered fire, and how to warm himself by burning objects. Now when he wanted to impact his environment, he added wood to the fire. But sometimes others were around, with their own preferences concerning the temperature. Means of communicating were invented, and methods for negotiating were developed.

Very little changed until the Industrial Revolution, when the means for communicating preferences changed from manually adding fuel to the fire to mechanical means for controlling the heat. Later, electrical means were added for controlling the environment, and more recently wireless means.

Recently, NEST Labs introduced the NEST Thermostat to control the temperature in a house by detecting when someone walks by the device and setting the temperature based on whether it can detect a person in the room. But this device suffers from difficulty determining when someone is in the room using its motion sensor, depending on where the thermostat is located. It also is incapable of determining who is in the room, or negotiating between multiple people with different temperature preferences.

Bill Gates, leader of Microsoft Corporation, has designed his home to adjust to the preferences of his guests. Apparently, guests are given a pin that is read by sensors throughout the house. The sensors then adjust the temperature, the music, and the lighting, depending upon the guest's preferences. However, this system seems to handle only the preferences of the last guest to pass the sensor, and is tightly coupled to the pin that each guest is given. In other words, it is a closed system. There is no way for guests to set their own preferences on their own device, or to change the preferences independently.

There are other Apps and software that sets preferences on a single device based on various parameters, such as Tasker App or SmartActions that modify the environment within a smartphone based on location, time, or other factors. However, these Apps do not change the broader environment and have no ability to interact with other devices.

Additional techniques that consider user preferences include billboard technology that changes the displays based on information parsed from video derived from a camera in the billboard (see Immersive Labs). Foursquare adjusts the information displayed on the smart phone based on the location of the device. Various shopping apps provide coupons and ads based on which store a user enters. While each of these changes the marketing based upon location of a user, none of these apps or devices integrate the preferences for multiple people.

Only in dating apps are their coordination of preferences between multiple users, but these apps do not impact the environment, nor do they negotiate between the devices.

This application overcomes these shortcomings by describing a paradigm for interrogating preferences from one or more users through their smart phones or other devices and coordinating the control of the environment, and personal behavior, by negotiating between the devices.

### SUMMARY OF THE INVENTION

A method of setting preferences in an intelligent device is described where the intelligent device searches a context for other devices and then exchanges preference tables with the other devices. The intelligent device executes a negotiation algorithm on the set of preference tables and sets a parameter based on the outcome of the negotiation. The negotiation algorithm could be one of a voting algorithm, a weighted voting algorithm, a last (or first) one in algorithm, a bidding algorithm, an averaging algorithm, a priority algorithm, a matching algorithm, or a sharing algorithm. The parameter can impact the behavior of the user of the intelligent device, the behavior of the intelligent device itself, the environment, or the behavior of others.

An environment management device that is made up of a processor, a communications system connected to the processor, an electrical interface connected to the processor, tied into an output device, where the communication system receives profiles from a plurality of profile devices, and the processor periodically runs a negotiation algorithm using the profiles received from the profile devices to determine a value used to set parameters in the output device. The negotiation algorithm could be one of a voting algorithm, a weighted voting algorithm, a last (or first) one in algorithm, a bidding algorithm, an averaging algorithm, a priority algorithm, a matching algorithm, or a sharing algorithm. The parameter can impact the behavior of the user of the intelligent device, the behavior of the intelligent device itself, the environment, or the behavior of others.

### BRIEF DESCRIPTION OF FIGURES

FIG. 1 is a diagram of four phones sending their TV network preferences to a television that uses a voting algorithm to determine the TV station to play.

FIG. 2 is a flow chart of an exemplary algorithm that could be implemented on a phone to manage preferences.

FIG. 3 is an example of a preference table for a phone.

### DETAILED DESCRIPTION OF THE INVENTION

In many instances in our lives, we make adjustments to our behavior due to the preferences of others. We put on our dress clothes to go to church. Waitresses automatically know how much sugar and cream to put in the coffee for regular customers. Students do not use their cell phones when in class.

And then there is the behavior of devices based on preferences. A setback thermostat sets the house temperature based on our preferences when we are home. Motion detectors turn a light on or off depending on our presence.

But these are very simplistic algorithms in very limited situations. The actual world of preferences is very large and complex, especially when multiple people have differing preferences. The present invention outlines a number of embodiments for collecting, managing, communicating, negotiating, and implementing preferences using proximity and intelligent device database algorithms.

### I. Creation of Preferences

The beginning of the process is the collection and creation of the preferences. In one embodiment, a smart phone has a preference table template built in the device and in other embodiments, certain organizations could create standard preference table templates based around their industry. For instance, the National Restaurant Association could create a standard preference table template for restaurant customers that would match the preferences of customers and servers so that the preference tables for customers and servers were compatible. In another example, the Android and iOS operating systems could come with a standard preference table template with fields for a picture of the user, the user's name, a voice print of the user, and other public personal information about the user.

Once the preference table template is loaded into the intelligent device, the table needs to be populated with data. In the following description, the intelligent device is a broad description of a number of devices such as smart phones, tablets, computers, smart watches, fitness monitoring devices, intelligent thermostats, intelligent appliances, intelligent televisions, intelligent audio equipment, security systems, intelligent access control devices, motor vehicles, printers, copy machines, intelligent industrial equipment, intelligent lighting, intelligent headphones, display devices, and the like.

Below is a list of methods for creating preferences. It is envisioned that one implementing this invention could use any one or any combination of these methods for creating a preference table.

A. User Enters his Preferences

The simplest method of populating the table is for the user to enter the data manually. Most operating systems already have the user enter simple preferences for the operation of the device at installation time, additional steps could be added this process to interrogate the user to enter data into the preference table. It is envisioned that the entry of this data would be optional, although it is not beyond the scope of this invention to force the user to enter some or all of the data in a preference table. For instance, a user may be willing to share his name but not his voice print, so only the name will be in the preference table. Given the potential for a very large number of preferences, it would not be unusual for a preference table to be partially populated.

It is envisioned that the user would enter the preferences through a keyboard, touchscreen, by verbally answering questions (e.g., using Siri, S Voice, Google Now, or the like). Any number of possible user interface techniques could be used, either a question and answer inquiry, a text editor, a topical context sorted by subject matter, a table, through a search for specific parameters (of groups of parameters sorted by subject), etc. The Preferences tool (or app) could be web based, local network based, or could run solely on the intelligent device. Once preferences are set, the user also requires an easy way to change the preferences that have been manually set or that are automatically set as described below. The same method used to enter or populate preferences may be used to edit preferences.

B. Preferences are Mined from Other Apps

Alternatively, or in conjunction to manual entry, an intelligent device could automatically mine information from other applications. For instance, the intelligent device could interrogate the NEST thermostat application and determine that the user typically sets the temperature at 69 degrees Fahrenheit. The temperature field in the preference table could then be automatically set to 69 degrees. Or the music preferences section of the table could be populated by interrogating the Pandora application and web site for data on the user's preference for music. The preferences may be exported from an existing account such as Google, Facebook, Amazon, etc. Alternatively, the preferences may be exported from an application on a user's intelligent device. Facebook, Amazon, and Google have large amounts of data on user preferences that could be collected. It is also possible that the user preferences are exchanged between the preference table and Google, Facebook, or Amazon.

C. Use Deduction to Determine Preferences from Above

Certain heuristic algorithms could be employed derive information from the data entered or from the data mined from other applications. For instance, if the NEST thermostat sets the temperature down ten degrees each day at 10:30 PM, the algorithm could deduce that bedtime is 10:30 PM, and turn the cell phone ring preference off until morning and turn the lights off at that time.

D. Adjust Preferences Based On

While some preferences are static, remaining unchanged once set, many preferences are dynamic depending on various criteria, such as, negotiation of preferences with another user.

1. Location

A user may have a set of preference tables that change based on the location of the user. For instance, the preference table for a church location could have the phone ring turned to off, change the phone background screen to a bible verse, and hold all text or email messages from arriving at the phone. At a work location, the phone ringer would be turned on, the corporate logo could be on the phone background screen, and all email could go through. And text may be limited to text messages from co-workers and not from friends while at the work location.

2. Time of Day

Similarly, the time of day could be used to determine which preference table is used. From 6:00 PM to 7:00 PM, for instance, the preference table could be set to Dinner, where the phone was set to block all phone calls, text messages, and emails. In addition, the phone could send the user's preferences to the audio system requesting soft music and that the lights be dimmed in the dining room, but at full intensity in the kitchen. Similarly, a profile for 6:00 AM could bring the Wall Street Journal app up on the tablet, request that the thermostat increase the temperature to 71 degrees, and turn on all of the lights in the kitchen area.

3. Proximity of Devices

The proximity of the intelligent device to another device could change which preference table is used. The proximity could be determined by RSS or time-of-flight distance measurements, or by using Global or indoor positioning systems (e.g., RTLS) to determine device locations. Once the two devices are determined to be proximate, the preference tables could be changed. For instance, U.S. Provisional Patent Application 62/081,881, entitled “Device Proximity Priority Manager”, hereby incorporated by reference, describes an invention where, amongst other things, the alert for the arrival of an email is only displayed on one device when multiple devices are proximate. One implementation of this idea is for a phone to have a preference profile that changes when the phone is close to a known tablet or a specific computer.

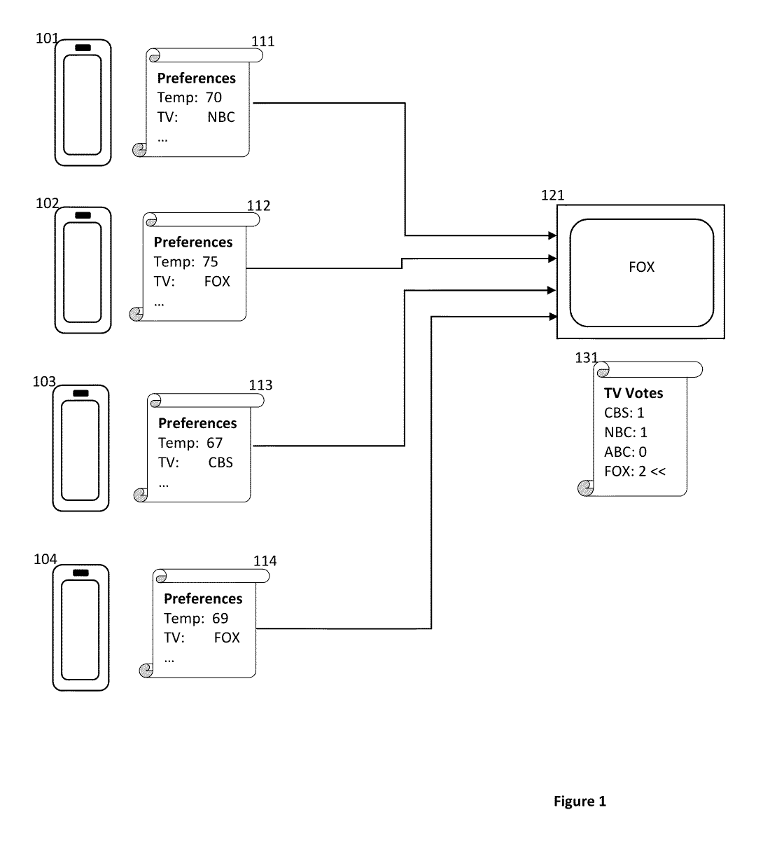

Another embodiment of this concept could be a group of devices negotiating for the setting of a preference. This can be seen in FIG. 1 where the intelligent television 130 changes its station based on the preferences set in the preference tables of the devices 101, 102, 103, and 104 around it.

4. Who Specifically is Around Us

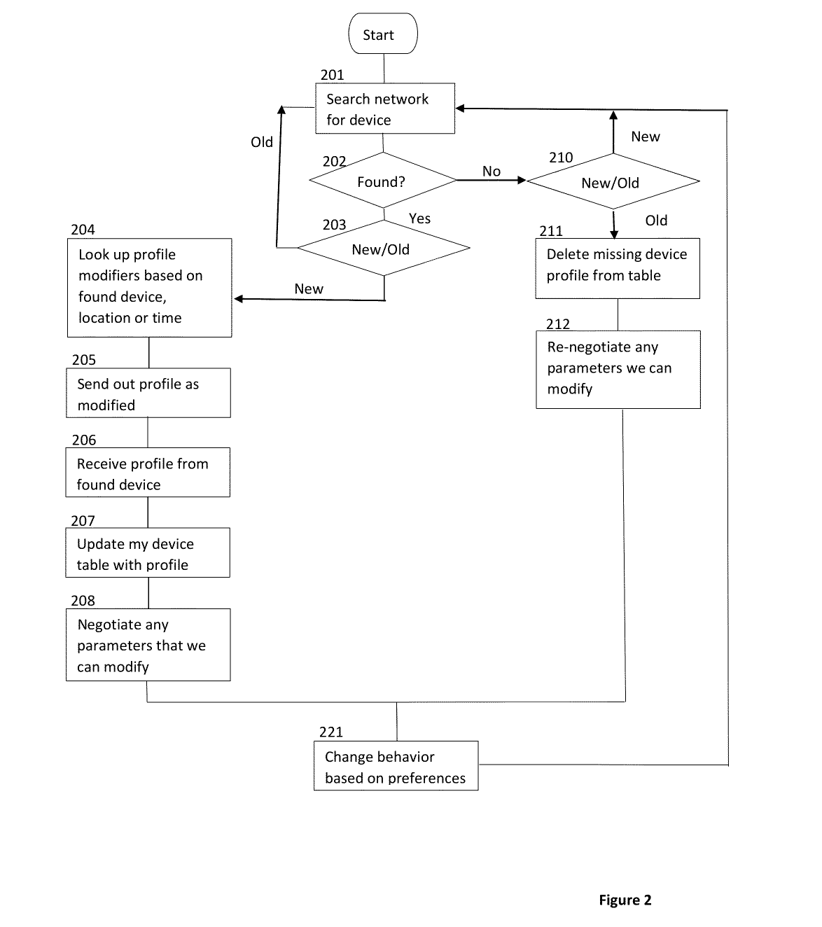

Furthermore, one of several preference tables could be selected based on who is near to the user. In this instance, if student is near his teacher, the phone ring tone could change in the preference table from a Bob Marley song to Bach. See 204 in the algorithm in FIG. 2.

In another example, a regular customer at a restaurant could transmit his preference table to the waitress signifying his preference to have cream and one sugar in his coffee.

5. Crowd of People Around Us

Similarly, the preference tables could change depending on if the user is in a crowd of people or in a small group. An example of this may be that the phone ring volume may be increased in a crowd, assuming a noisy subway car, and then reduced in the quiet of a small group of people.

E. Implied Preferences—i.e. the Boss Comes into the Room

Some preferences are taken from other devices or people as the intelligent devices share their preference tables. In other cases, the presence of a device or person will cause a set of implied preferences. For example, the presence of a user's supervisor may imply that the preference table is modified to prohibit games and Facebook on the computer, even though the data table from the supervisor does not contain preferences related to these attributes. This technique can be seen in step 204 in FIG. 2.

### II. Storage of Preferences

There are a number of locations where the preference tables could be stored for the user or for various devices. The invention is not limited to these storage locations, and could support other storage schemes. Furthermore, any one of the below storage location or any combination of the storage locations could be used. The preference tables are searched in step 204 of the algorithm in FIG. 2.

A. Locally on Intelligent Device

The most obvious location to store the preference tables within the intelligent device itself. Most intelligent devices, cell phones or tablets, for example, have ample storage for holding the preference table. Since the device typically moves with a user, its location is an important indication of which other devices a preference table should be shared with. Even smaller intelligent devices, such a thermostats, appliances, or smart tags, typically have more than enough memory to hold a preference table for that device.

B. On a Tag or Other Portable Device

Another location for the preference table would be within a smart tag attached to an item. For instance, a smart tag could be attached to a hard hat and the preference table could be used to grant or deny access to specific elevator floors based on the smart tag. This would allow workers without hard hats on completed floors but not on floors still under construction. In this case, the preference table is stored in the tag and not in the hard hat itself. In some implementations, a smart tag attached to an intelligent device to offload the preference table storage and processing to the tag.

C. In the Cloud

The preference table could also be stored in the cloud or on a local server. In these embodiments, a unique table is stored on the server, and the location or proximity information is sent to the server for processing and determining which preference table should be shared or negotiated.

III. Negotiation of Preferences

Preferences can exist on a single device and serve to express the desires of a single user. Alternatively, preferences can reflect the desires of a group through some process for the negotiation of the preferences. The negotiation process compiles the desires of individuals into a collective preference. The negotiation can be a singular event or can occur continually. In the example of the TV in the doctor's waiting room, the station can be set by the first person in the room (static), or through a negotiation between those in the room when the TV is turned on (singular negotiation), or the station can change dynamically as people enter and leave (dynamic negotiation). This negotiation process is incorporated in the algorithm in FIG. 2 as step 208 and in step 212.

It is envisioned that one implementing this invention could use any one or any combination of the below negotiation techniques.

A. First One Sets the Environment (Static)

The most primitive means for negotiating preferences is statically, where the first user sets the preference permanently. This is not an algorithm but the setting of a value. In the doctor's waiting room example, this is the equivalent to the staff setting the station, perhaps on a medical information station, and then locking the control panel. The preference table for the TV, in this instance, is set by the staff initially, and never changed.

B. Last One In—Last to Transmit Changes Environment

Another embodiment for the setting of parameters is that the last one to arrive sets the parameter. This, too, is not an algorithm but the setting of a value. In the waiting room example, each person, as they arrive, changes the channel to the station they desire to watch. In the preference table world, the TV preference table is overwritten by each new intelligent device that sends a preference to the TV. In some embodiments, there may be a delay in changing the preferences so that the TV channel is not changed for someone walking through the room without waiting. In another embodiment, the location mechanism is precise enough to determine which device is associated with a chair and which are moving or talking with a nurse. This may use an indoor positioning system or an enhanced GPS system.

In one embodiment of the last one to arrive algorithm, when the last device to arrive leaves, the intelligent device removes that preference and returns to the preference previously set, should that device still be present. If no devices are detected, the intelligent device could turn the device off or to a default state. This is a standard computer science stacking algorithm. In the waiting room example, the TV would set the channel based on the last one to arrive; once that person left the waiting room, the TV would restore the preferences previously set, and check to see if the person who set that channel were still present in the waiting room. If not, the previous preferences would be used if that person were still in the waiting room. If no one was in the waiting room, the TV may turn off until another person arrived.

Alternatively, multiple intelligent devices could negotiate amongst themselves and then decide that one intelligent device would send the negotiated preference to the TV for its implementation of a last one to arrive algorithm.

C. Voting

Another way to negotiate the preferences between several devices is to create a voting mechanism. The voting could be done once amongst all that are present at a point in time, or could be dynamic, changing as devices arrive and depart a certain location. Alternatively, the voting could be done at regular intervals, such as every half hour for the choice of a TV station, corresponding to the times when a show ends. The voting could also be done ahead of time. For instance, if a meeting is planned for a certain time amongst a set group of people, the smartphones of the participants could vote on the temperature of the room, type of food and beverages available, and the background music in advance of the meeting, and the room could be setup when the participants arrive.

1. Highest Vote Count Wins

While there are multiple types of voting algorithms, the most common involves a democratic process of one vote per device. In this process, the votes are compiled with the highest voted preference being set on the intelligent device. With impromptu voting in waiting rooms and similar, often there will be ties in the voting due to the small number of votes for the preference. As a result, the tie vote algorithm is important. Ties could be resolved by randomly selecting one choice, maintaining the previous choice (this option is preferable, as it provides stability in the selection), or using the last one in.

The voting algorithm for setting preferences can be seen in FIG. 1, where four patients with smartphones 101-104 are in a waiting room. Each phone 101-104 has a preference table 111-114 that specify, amongst other things, their desired TV network. The TV 121, asks all devices in the room for their choice for a network to play on the screen. The TV creates a preference table 131 that includes columns for each smartphone 101-104 that it detects, and sets the station, FOX, based on the highest number of votes from the smartphone 101-104 preference tables 111-114.

2. Weighted Voting

In another embodiment, the voting could include weighted votes, where some devices have more or less clout in the voting. For instance, one patient may not care which TV station is played, so the patient may set their vote weight to less than par. Another patient, perhaps a mother with young children, may set a higher weight to set the channel to a PBS station rather than the adult content on daytime soap operas. This algorithm requires the cooperation of all users to prevent everyone from setting their preferences to the maximum, which changes the situation into a pure voting algorithm. One option would be to force users, using software in the user's device, to only increase the weight on a vote if they lowered the weight on another preference. Thus, for someone to weigh their vote on the TV channel higher than par, they would need to lower the weight of another preference, say the brightness of the lights.

Another solution to the balance of weight issue is to allow users to pay for the right to increase the weight of their preferences. These payments could go to the owner of the intelligent device, for instance to the doctor who owns the TV in the waiting room or the payments could be made to a central preference management agency.

The code to implement a voting algorithm on an intelligent device involves searching the preference devices in proximity to the intelligent device. Once the devices are found, preferences are requested from each device. An array of choices with the count of the selected choices is created. For each preference table from the devices, the preference is searched through the array. If the preference is found, increment the count by the weighting factor (or one if using a straight voting algorithm). If the preference is not found, the preference is added to the table and the count for that preference is set to the weighting factor (or one). Once all of the device preference tables are processed, the array is searched for the highest count. If there are multiple preferences that have the same count, one of the preferences (perhaps using the first device to respond's preference or the lowest address's preference or by using a random number generator to select between the preferences) is randomly selected.

D. Averaging

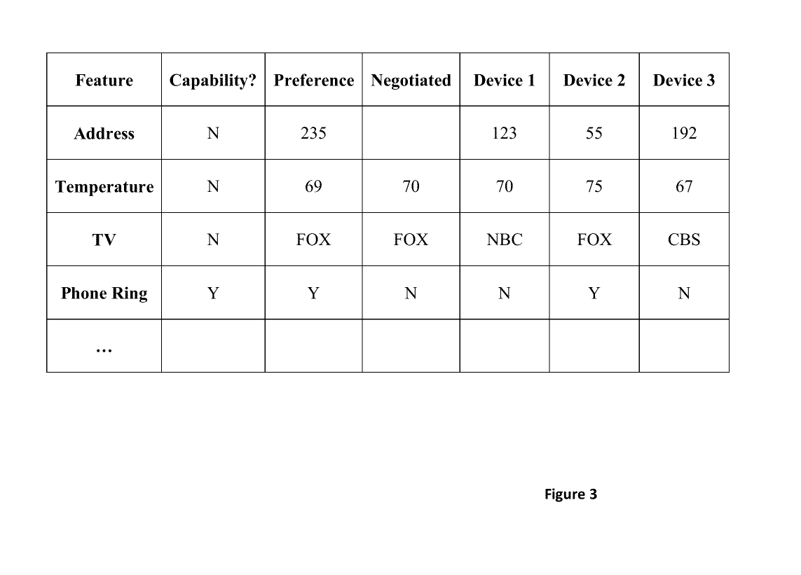

The nature of some parameters lends itself to an averaging algorithm. Setting the temperature in a room, for instance, would naturally work with an averaging algorithm. In FIG. 3 the three devices Device 1, Device 2, and Device 3 have temperatures 70, 75, and 67 degrees. Averaging these three preferences gives a parameter of 70.6 degrees, which will make everyone fairly happy. Of course, there is the possibility of someone gaming the system by setting the temperature to an extreme with the hope of overriding everyone else's preferences. This may be dealt with by ignoring outlier preferences. For example, if Device 4 was added to FIG. 3 with a temperature of 50 degrees, this preference could be ignored by setting parameters on the preference table of the intelligent device to only accept temperatures from 60 to 80 degrees.

A weighting factor could also be added to the averaging algorithm to provide some users with additional influence, for instance an individual with an illness may use the weighting to increase the temperature over the average of the others nearby.

The code to implement the averaging algorithm on an intelligent device involves searching the preference devices in proximity to the intelligent device. Once the devices are found, preferences are requested from each device. Take the preferences from each device's preference table, and compute an average of the values. Set the parameter to the average value.

E. Priority Algorithms—Doctor can Always get Phone Call

Independently or in conjunction with the above algorithms is a priority algorithm that allows certain individuals to set their preferences over the preferences of others. For instance, in a preference scenario for a church, the phone ring preferences for all phones could be set to silent upon entering the sanctuary. But a doctor could override that preference so that they are always able to receive an emergency call.

Or in our example of the waiting room, a deaf person could set a priority preference in his preference table that is communicated to the closed caption preference on the TV, forcing the closed captioning to appear on the TV.

The code to implement the priority algorithm on an intelligent device involves searching the preference devices in proximity to the intelligent device. Once the devices are found, request preferences from each device. Check each preference table for a priority flag, and set that parameter if the priority flag is set. If there are multiple devices that have set the priority flag and are requesting conflicting preference, randomly select one of the devices (perhaps using the first device to respond or the lowest address or by using a random number generator) and use that preference.

F. Sharing Algorithm—You Set the Temp Last Time so I get to Set it Today

Another negotiation embodiment is a sharing algorithm. This algorithm works best with a small group who negotiate the same preference frequently. The intelligent device stores the history of how the parameter was set, and selects the preferences from the preference device that has least recently selected the particular parameter. For instance, in the waiting room example, if all four people visit the waiting room every week at a set time, the TV would play NBC one week, Fox the next, CBS the third week and Fox the fourth to make sure that each person had their share of time selecting the channel.

The code to implement the sharing algorithm on an intelligent device involves first selecting a time period, say hourly, to search the preference devices in proximity to the intelligent device. Once the devices are found, request preferences from each device. After checking each preference table for a priority flag, look up each address of each responding device in the history table to see if that device has a history of setting the parameter and when it set the parameter. Sort the list of devices by the time when it last set the parameter. If there are multiple devices that have not set the parameter, randomly select one of the devices (perhaps using the first device to respond or the lowest address or by using a random number generator). Store the address of the selected device along with the date and time in the history table.

G. Bidding—Highest Wins

A bidding algorithm is another way to handle the negotiation of preferences.

With this algorithm, users bid using some form of value to get rights to set the preference. In the waiting room example, two parties in the waiting room could offer increasing bids for the right to set the channel, with the highest bidder's preference determining the channel that is displayed on the TV. Payment for the highest bid could go directly to the owner of the intelligent device, the doctor in the waiting room example, or to a central preference agency.

A central preference agency may be associated with a template distribution organization or with an organization that provides the app to support all or a set of preferences. An organization may take a form of remuneration (credit card, purchase order, billing account) from the user of the intelligent device and allow the user to bid and pay for setting their preferences.

In an extreme example, the background music at a ball game could be controlled by a bidding algorithm, with the ball park owners auctioning off each song played during the game, or perhaps auctioning off the rights to display messages on the Jumbotron.

In another embodiment, the user could chose to endure various advertisements in exchange for the right to bid on a preference. For instance, in exchange for the right to set the temperature in a restaurant, the user agrees to listen to pitches for the filet mignon dinner and the escargot appetizers. As the user increases his bid, he agrees to listen to further advertising on his device.

The code to implement the bidding algorithm on an intelligent device involves searching the preference devices in proximity to the intelligent device. Once the devices are found, request preferences from each device. Put each preference, along with its bid, into an array. Sort the array by the size of the bid. If there are matching bids, select the first bid received. Notify the bidders of the selected parameter and the highest amount bid. Request additional bids by collecting the preference tables from the device again. Continue until no changes in the bids are found within a set period of time, say a minute or so. Collect the bid amount from the highest bidder and set the parameter to the bidder's preference.

H. Matching

A matching algorithm could be used to match similar interests between two or more preference tables. For instance, one preference table may say that it has something to sell and another's preference table may indicate that it is looking to buy something. The matching algorithm matches the selling and buying interests, and takes an action. A student may set in his preference table that he has a Calculus book for sale and another student may set his preference algorithm that he is looking to buy a Calculus book. As the students pass each other entering the Engineering building, their mobile phones match the preferences tables, and notify each of the potential transaction.

I. Proximity

Proximity can be used to set the preference table in an intelligent device, either by fiat or by a weighting scheme with the most proximate device having a proportionately higher weight. An example of this would be a dynamic advertisement in a store. The advertising device at a resort may poll the room to see who is closest to the device, and then check the preference table of that person to determine their preferences. For example, the people may be interested in sailing, swimming, or sunbathing. Once the advertising device reads the preference table of the closest person, then the advertising video will switch to a sales pitch for boat rentals, swimsuits, or sunscreen depending on who is closer.

The shuttle bus from the airport to the resort may poll the preference table for everyone on the bus to determine which video to play, and then process a weighted voting algorithm to determine which video to play, with the weighting based upon how close the riders are to the video screen. Those right under the screen have more weight in their vote than the riders at the back of the bus.

J. Set all Preferences

Another form of negotiation involves the collection and incorporation of the preferences from all users. For instance, everyone entering an elevator would set the floor as their preference for the elevator and the elevator would stop at each floor selected. By using an automated preference system rather than the user hitting the button for the desired floor, the user saves the risk of getting germs from the elevator button and always selects the exact floor desired (no mistakenly hitting the button for a wrong floor).

This form of negotiation may also fit well with a priority scheme. In the elevator example, the doctor could have priority and his floor would be serviced first, but all users would have their floor handled when appropriate.

Other scenarios where the automatic setting of all preferences would be desirable include automatically checking in at the doctor's office at arrival, without having to talk to the receptionist. Or at the airport, allowing a user to automatically check in for a flight by showing up at the airport. Another scenario involves automatically adding a patron's name to the queue for seating at a busy restaurant, and then receiving a text message when the table is ready.

K. Time of Negotiation

In all of the above algorithms, the timing of the negotiation could be almost instantaneous when the device arrives in the proximity of the intelligent device, or the parameter could be pre-negotiated between those anticipated to be proximate to the intelligent device. For instance, when a meeting is planned between a group of people, the preference of each attendee could be polled and the room temperature could be negotiated in advance, allowing the room to be at the desired temperature when the meeting participants arrive.

L. Feedback

Feedback on the setting of the parameter may be important in some situations. In the case of the waiting room TV, the setting of the parameter is obvious when the station changes, but the reason may or may not be obvious. If there are three people in the waiting room, and a fourth arrive simultaneously with a station change, it is obvious that the new arrival changed the station with his preferences. In a polite crowd, this may be desirable as the other patrons know who to ask to reset the preferences back to the station that everyone was watching. But in an emergency room waiting room late at night, the new arrival may not be safe if everyone knows that whose preferences changed the station.

Display of other types of preferences could be through some form of display. With a thermostat, the temperature setting is often displayed on the screen of the thermostat. A secondary screen may be desirable to display the preference tables so that the reason for the temperature can be debugged. For instance, if the room temperature rises to 90 degrees, it would be useful to see if someone had set their preference to a temperature of 120 degrees, or if there is a failure in the HVAC system. This debugging screen could be protected by password to protect the privacy of the preferences.

M. Visibility of Preferences

Many preferences are exchanged between intelligent devices to negotiate behaviors, so most preferences need to be visible to applications on all devices. For instance, a student may broadcast in his preference table that he is looking for help with his math homework. His desire is that everyone he passes see his preference, and that someone have their preferences set that they are looking for students to tutor in math. Properly implemented, the intelligent device, in this case the students' smart phones, the apps on the cell phone exchange the preferences and check for matches on the math tutoring preferences. The students only see a notification if there is a match. When the match occurs, the phone may ring and vibrate to notify the students that a match has occurred. Then exchanged information from the preference table is displayed. Perhaps the name, a picture, and the preference match is displayed on the smart phone, allowing the students to introduce themselves.

Since preferences are sent over a network, either Bluetooth, WiFi, Cellular, Internet or other, in theory all preferences are visible to all other devices on the network using a network sniffer device. So an app on a smartphone to collect all preferences in a table and display all other user's preference would be easy to create. This may be useful for debugging purposes and to snoop on other's preferences.

But this may not always be desirable. Alternatively, the preferences could be encrypted with only the station who utilizes that parameter allowed to read the preferences.

In some embodiments, it may be necessary to negotiate the visibility of preferences. For instance, if a shopper is seeking an antique vase to give as a Christmas gift to his wife, he would want to hide that preference from her so that she would not know about the gift. The application would have an interlock that first sought the identity of the proximate device, and only if that device were in, or not in, a list of devices with which the preference could be shared would that portion of the preference table be shared. This is step 204 in the algorithm in FIG. 2.

N. Who Performs the Negotiation

The negotiation could be performed in several difference locations. First of all, the negotiation could be performed in the intelligent device that is using the parameter. In the case, for instance, a thermostat could collect the parameters and perform the negotiation itself.

In another embodiment, the preference devices could negotiate amongst themselves and then one preference device could send a single preference table with the negotiated preferences.

In another embodiment, the preference devices could send their preferences to the cloud along with their location information, and a server in the cloud could perform the negotiation between the preference tables of the devices in a specific location and then transmit the negotiated preference table to the intelligent device who is looking for the parameter to be set.

O. Implied Parameters

While most preferences are direct, some preferences can be implied by signals from the surroundings. The receipt of a preference table from another device could cause a set of preferences to be set due to the proximity of that device. For instance, an employee could create a separate preference table that is initiated when in proximity with his supervisor. This supervisor context preference table could force the employee's smartphone to discontinue all games and Facebook displays and put the company logo on the screen. When the supervisor is not proximate, Facebook and games could be allowed.

In another embodiment, a waitress could create a preference table for each of her regular customers. When her mobile device determines that a specific customer is proximate, that customer's preference could be loaded into her order taking software, allowing the regular order of eggs, toast, and black coffee to be automatically sent to the kitchen when the customer enters the restaurant. This is subtly different from the customer sending the order with his preference table; instead the preferences are implied simply by the customer's presence. In another embodiment, the restaurant could contribute (or sell) the customer's preferences to a central database so that other restaurants could use this information. And any restaurant with access to the central database could load the order based on the customer's preferences as found in the central database.

IV. Context

Preferences need to be viewed in a specific context, or the volume of data becomes unreasonably large, and the noise from the preferences of irrelevant users makes the parameter unresponsive to those who are most impacted by the preferences. Typically, an intelligent device is interested in being responsive only to those closely around it. People in other rooms are not relevant to the temperature, lighting, or TV station viewed in a room. In most situations, only those within the room have interest in setting the room parameters. The context is specific to those in the particular room. In other situations, the context is virtual or relational. Context is determined in step 201 in the algorithm in FIG. 2.

A. Proximity

Proximity is an important element in the determination of preferences, as many preferences are relevant only within a certain context, and proximity is a key element of context. There are many ways to determine proximity, each with their benefits and shortcomings.

1. Bluetooth and BLE

Bluetooth offers a protocol and frequency that cover a room or building size range at a frequency that easily goes through walls and other materials. Bluetooth Classic has a range of 10 meters (30 feet), and many BLE implementations match that range. However, BLE does not specify a range, so implementers can specify shorter or longer ranges (up to around 100 meters). BLE is also widely implemented in cell phones, tablets, and PCs, making it easy to find support in typical devices. Proximity using BLE can be determined using RSSI or time-of-flight (see U.S. Provisional Patent Application 62/079,861, “Location of Objects Using a 3 Dimensional Mesh Network,” incorporated herein by reference). Alternatively, every intelligent device within the range of the Bluetooth signal could be considered to be proximate enough to be within the context.

2. WiFi and Other Protocols

WiFi can also be used to determine proximity. It offers ranges longer than BLE and similar characteristics for penetrating walls and other materials. WiFi is also widely implemented, but uses more power than BLE. Also, protocol issues make it less optimal than BLE for proximity applications. Range of signal, RSSI, and time-of flight algorithms could be used to determine proximity using WiFi.

Other protocols that could be used for proximity sensing via range, RSSI or Time-of-Flight algorithms include cellular protocols or custom RF protocols.

3. NFC

Near Field Communication (NFC) is designed for proximity determination, as it only works within short distances (e.g., within 10 centimeters). It is often used to transmit a small amount of information between the two devices. The ability to read the signal (the range) of a NFC device can be very effective to determine proximity.

4. Visual

Another method of determining proximity is through a camera, allowing the intelligent device to “see” what is proximate, and to use image recognition software to determine if an object is proximate. This could be in the form of a device determining that a person or that many people are in the room, or a Google Glass type device scanning a room to find a QR code that provides information on what other devices are in the room. A device could look for UPC codes or could read room numbers to determine the context of the environment. In one embodiment, a user wearing a Google Glass type device could scan the room for a Google Nest thermostat, and if one is seen, execute an app to find the address of the Nest thermostat and transmit preferences to the Nest to set the temperature to a certain value.

5. Audio

Proximity can also be determined via sound waves and audio processing. The microphones on a smartphone or other intelligent devices could be used to listen for various sounds to determine a context. For instance, a user's smartphone could listen for voice prints of certain individuals, and then determine context from that voiceprint. When the voiceprint determined that a certain individual was present, the preference table related to that individual could be used, such as in the case above where a student's ring tone preferences are changed when in the presence of a teacher. See 204 in the algorithm in FIG. 2.

Other uses of audio may be to set preferences when the noise level reaches a certain point. Should a user's phone determine that the noise level has exceeded 80 dB, switch the phone ring parameter to include vibrate, as the background noise is too loud to hear a ring.

Many other scenarios can be envisioned, such as the determination, using audio analysis, if the device is in a crowd, or on a subway, or driving on a highway.

6. GPS or IPS

Global positioning systems or indoor positioning systems can be used to determine the location of the intelligent device, thus providing a location based context for the preference system. By comparing the location to the location of other intelligent devices, the proximity of the devices can be determined. In one embodiment, a set of intelligent devices transmit GPS coordinates to a cloud server, and the cloud server determines that the devices are all at the same general location, say at an outdoor concert. The cloud server then collects song preferences from each intelligent device within the location of the concert, and automatically updates the band's list of songs to play based on the preferences.

B. Virtual Event

While proximity or absolute location provide a physical context, virtual contexts are also important in some situations. For instance, everyone on a video chat site may share their preferences for acceptable topics for conversation. The preferences may be managed by a central cloud server or by the video chat site software and may be managed automatically by a voice recognition software that warns and then disconnects devices that violate the negotiated preferences.

1. Internet Connection

Determining context in a virtual online situation can be conducted based on a network or interne connection. Everyone connected to a certain web site or connected to a certain server are considered part of the virtual context. A simple example of this is in online gaming; everyone participating in the game is part of the context, each player transmits their preferences for the variant of the game to the game server, said server negotiating between the preferences and setting the variant parameter for the game.

2. Skype

In another embodiment, the context could be determined based on participation in a Skype conference (or a WebEx or GotoMeeting or similar videoconferencing service). Everyone who participates in the conference is said to be part of the virtual context, and are allowed to specify their preferences. These preferences could specify the relative volume of the speakers, whose video feed is displayed, or who is allowed to markup the video feed.

3. Phone Call

Similarly, the telephone system (hardwired and/or mobile) could be used to create a context surrounding a phone call or a conference call.

4. Virtual Communities

Another source of virtual context is with online “communities” such as Facebook, Google+, LinkedIn and other social networking sites. Each has the concept of “friends” or “circles” or “connections” that create a virtual context for a specific user. This context can then be used to collect preferences and negotiate the setting of parameters. For example, if a group of friends create a Google+ Circle regarding an interest in a common online police scanner, the group could provide preference as to which frequencies are scanned and which direction the antenna is pointed. Once the preferences are negotiated, the antenna could be moved and the frequency set. This may be of particular interest during an incident, where the users want to temporarily change the parameters to focus the scanner on that incident.

C. Relational

In addition to virtual and physical context, relational contexts are also important to set parameters. Relational contexts could include family, friends, employment, or club membership.

1. Family

Within the context of a family, there are many preferences that could be used to negotiate parameters, from the setting of the TV channel in the living room to the dinner music in the dining room to what type of wine to serve with dinner. While proximity may be important in these decisions, other family members who are not proximate may have an interest. Parents may want to influence the TV channel selection when the babysitter is watching the children. Or a family member who is traveling may want to make sure that the best bottle of French Champagne is saved for an upcoming dinner party, thus voting their preference that the online lock on the wine cabinet not be unlocked for tonight's dinner.

2. Employment

Similarly, employees both remote and local may have a contextual interest in the setting of parameters for the company. For instance, the employees on site, the CFO, and the CEO all have an interest in the temperature of the office, some for cost containment issues, some for comfort, and others for productivity reasons. Each of their preferences could be negotiated to set the temperature parameter for the site.

3. Club

Clubs are another context where preferences are important. A Ham Radio club could collect preferences from the club members on the direction of the club's repeater's antenna direction. Or the members of a church could specify the temperature of the sanctuary 45 minutes before the service so that the room has time to warm up before anyone arrives.

### V. Methods of Identifying

Within a preference table, an intelligent device needs a method for identifying individual devices within the context. In some preference tables, an individual intelligent devices preference is important. For instance, the waitress reading the preferences of her customer's needs to know specifically which customer wants the coffee with cream and sugar. There are a number of methods of identifying individual devices (e.g. associating the preference table with an individual device or with the person holding the device), from using the device's address to the exchange of photographs to proximity data. The methods for identifying the unit are used in steps 202 and 203 of the algorithm in FIG. 2.

A. Device Address

Device addresses are available on most networks. On Bluetooth networks, devices provide a device name that contains information about the device. When looking for a TV to send channel preferences to or for a thermostat to send a temperature request to the name of the Bluetooth device may be sufficient to identify the individual device. But unless the patron at a restaurant is looking at his phone, this name may not be helpful to the waitress.

MAC or IP addresses on a WiFi network provide even less information to the user, but are still a viable alternative for identifying an intelligent device in some circumstances. A WiFi SSID provides more information, but often is still too cryptic to assist the waitress in determining who is requesting coffee.

B. NFC Exchange of Identifying Information

NFC provides better information for the user because of its limited range. If the intelligent device picks up the NFC signal, then the device can assumes that the nearest device is the desired device. In this scenario, the waitress walks past her customers until her intelligent device detects via NFC the device that requested the coffee.

Furthermore, NFC is often used to transfer a fixed set of identifying information. Originally intended to communicate credit card information, the packet also typically contains a name and could be configured to transmit addition descriptive information such a height, eye and hair color. All of this information is very useful in determine the specific intelligent device that provided its preferences. The shortcoming, of course, is the limited range of NFC.

C. Camera—Facial Recognition

Another means for recognizing an intelligent device is by comparing a picture to the person holding the device. Along with the preferences, the intelligent device could send a picture. The receiving device could then use facial recognition to identify the proper intelligent device or could transmit the picture to a person to search. In our example of the waitress, she could look at the picture on her smartphone and then scan the restaurant for the person who sent in their preference for coffee with cream and sugar.

D. Voice Recognition using Phone Microphone

Voice recognition could also be used to determine the specific person holding the intelligent device that sent its preferences. The microphones on the intelligent device could be used to determine direction and later could be used to identify the person. In our waitress example, the waitress's smartphone could scan the sounds of the restaurant for the voice print that was sent with the preferences. Once the smartphone hears the voice, it would tell the waitress the direction to head until the smartphone reached the individual with the voice from the voiceprint.

E. Location—Specific Location

An easier method would be the use of an IPS or GPS to specify the specific location of the intelligent device. For a static device, such as a thermostat or a TV, the precise latitude and longitude could be used to specify where the device is located. The receiving device then uses this location information to go to the specific location where the preferences came from.

F. Proximity

Time-of-flight, RSSI, or the triangulation technique described in U.S. Provisional Patent Application 62/034,747, “Finding Devices Using Cell Phone Sweeping”, hereby incorporated by reference, could be used to determine the location of a specific intelligent device using proximity methods (see description above). In addition, a directional antenna could be used to assist in the determination of where an intelligent device is located.

G. Time of Day

In addition, time of day can be used in some situations to determine specific intelligent devices, particularly when the device uses a regular schedule. A train, subway, aircraft or other scheduled device could be identified by its arrival at a scheduled time.

VI. Parameters

There are a very large set of parameters that can be set through a preferences model. Below is a representative list; a person of skill in the art could envision many other parameters within the context of this invention. Parameters could be contextual or permission based, that is, the parameters could only apply within a certain context or that they may be set according to permissions.

Parameters could involve requesting or assisting the owner of the intelligent device with various behaviors, or modifying the behavior of the environment. Parameters could be set directly through preferences or through a negotiation process.

Preferences are typically transmitted through a data structure that is understood by the receiving device. This could be in the form of a pre-defined table, metadata, or through an XML type structure that incorporates tags that can be parsed by the receiving device to determine applicability.

A. Open Platform

In some instances, a set of preferences could be assembled in a closed system with all participants sending the same packet every time, but in a more general implementation the preferences would be sent using an open architecture. The open architecture allows other vendors and users to create their own preferences, and add these to the overall preference table.

1. Specific Organizations

Specific organizations may decide to create their own standard preference tables that allow for common communications between devices within that context. For instance, the National Restaurant Organization may create its own preference template that is distributed through apps for waitresses and customers. The customers could enter their order and preferences into the app, which would populate the preference table with certain information. For instance, the preference table could include the customer's name, preferred nickname, a picture and a physical description, table number or specific location information, preferred drink, standard order, the specific order, how fast to be served, orders for accompanying people, and any special requests. The app on the waitress's phone receives this preference table and is able to parse this information onto the screen for the waitress to process. She then knows how to address the customer, how to prepare the coffee, and to place the order quickly, if the preference table so specifies. The National Restaurant Organization's standard template makes this communication of the preference table simple because of the standardization.

2. Other Fields

Other organizations and vendors are expected to also create standard templates for their fields. Various military organizations would set up preference tables, as would clubs, churches, governments, and companies.

B. Changing User's Behavior

One area where preferences are very useful is in the determination of how the owner of the intelligent device is to behave in certain situations. We often encounter situations where we are unsure how to dress or act in an unfamiliar context. Preference tables provide a means for discretely interrogating an intelligent device for advice on how to behave.

For instance, if we are invited to a party at a function hall. We link to the function hall's or to the event's server to download the preferences, perhaps to our smartphone. These preferences would be parsed by the smartphone, and by looking at an app on the smartphone, we can see the preferences for the event. The preferences may specify the dress code, whether smoking is allowed, whether swearing is appropriate, whether drinking is allowed, and if so, whether there will be a cash or open bar, the level of formality in communications (must everyone be addressed as Mr. or Mrs., or will we be using nicknames), preferred subjects of conversation, conversation subjects to be avoided, level of politeness required, whether it is ok for mobile phones to ring at the event, whether it is ok to receive text messages at the event, and other parameters that impact our behavior. These preferences could then cause other preferences to be set on the user's device indirectly. For instance, if the event is designated as formal, the mobile phone background display could be changed to display a formal picture of the owner and his wife rather than the default background picture of the children and the dog.

In another scenario, the user could poll the preferences of the other patients waiting in the doctor's waiting room for information regarding contagions. If the patient thinks they have the flu, and specify it in their preferences, the other patients in the waiting could check the preference tables and use that information to determine where to sit in the room to minimize the risk of infection.

C. Changing Other's Behavior

Preferences can also be used to change, or to try to change, the behavior of others. By creating preferences regarding other's behavior, the user can subtly set expectations should others decide to respect the user's wishes.

1. Health

With epidemics of flu and Ebola and other diseases, a user could use the preference tables on his intelligent device to determine the health of those around him. For instance, the user could poll those proximate to him for information on locations recently traveled to, what the body temperature is of the others in the room, whether they have been recently sneezing of coughing, pharmacy record or medical records. There are privacy concerns with this information and may be restrictions on sharing, but in some contexts a person may want to share this information or may be forced to share the information. Someone who is sick with the flu may agree to make that information public to assist others in avoiding getting sick. In other situations, the government may determine that there is a health emergency and require those who are sick to make that information available in their preference tables.

2. Driving Skills

Another area where the preferences of others could be important is in the polling of the preference table from drivers in the cars surrounding the user. It would be useful to know that the driver in the car in the next lane is a 16 year old with 3 weeks of diving experience so that the user could quickly move away from that vehicle.

The ability to push preferences to other drivers may allow several drivers to agree, via their preference tables, to synchronize their cruise control speed so that the multiple cars could travel down the highway at the same speed. This would increase safety as the lane changes and speed adjustments are limited and the fuel efficiency would increase as the cars travel at a constant speed and draft each other.

3. Waitress Options

The restaurant experience could be enhanced for both the customer and the waitress by exchanging preferences. The customer could let the waitress know not to bother the customer, or that the customer is in a hurry, or that the customer is waiting for someone, or that the customer wants the coffee cup full. These preferences allow the waitress to know the customer's expectations and lets her know how to behave towards the customer. The preference table could even let the waitress know to put the cost of the food on the customer's tab (and which customer's tab to add it to).

Additional information concerning payment could be included in the preference table. For instance, Apple Pay, a house tab account, or a credit card could be included in the preference table to provide to the waitress. Of course, security technology such as an encryption method may be needed to protect the payment information. Alternatively, the secure payment preference table could be shared only with the restaurant point of sale system, keeping all payment information from the wait staff. A preference to always pick up the check (or never pick up the check) could also provide the waitress information on who to deliver the check to. Additional information in the preference table on a default tip amount could make the entire payment protocol an electronic one with no physical interaction concerning payment.

4. Cashier Options

Similarly, cashiers could be informed not to ask for donations and not to ask the customer to sign up for a credit card. The question of whether the customer wants a receipt could also be eliminated by collecting the answer to this question from the preference table.

5. Sales Techniques

For salesmen, information in a customer's preference table could be invaluable in the determination of how to pitch a sale. Does a hard sell work or should a soft sell be used? Picking the wrong approach will annoy the customer and may lose the sale. But if the customer put this information in preference table, the customer is happy with the sales approach and the salesman is happy to make the sale.

6. Respect of Preferences

Since others are requesting that a user respect the wishes specified in preference tables of others, one important piece of information is whether a user respects the preference wishes of others. This preference could be set directly by the user, set via software, or other users could set this preference in the user's preference table. Three settings for this preference are envisioned: typically respects other's preferences, typically ignores other's preferences, or typically rebels against other's preferences.

7. Have we Met Before

For salesmen, politicians, and in many other situations, it can be important to know if we have met someone before. Preference tables with their identifying information can be used to database who we have met and to use that identifying information to lookup contacts to see if the person in front of us is someone we have met before. When an intelligent device enters a context, all accessible units are polled for their preference table. If the returned preference table (or even just a MAC or IP address, SSID, or Bluetooth device name), the intelligent device performs a search of a database (located either on the device or on the cloud). If the search is successful, the user is informed of the date and time (or multiple date and times if there have been many contacts) that the other device was previously found. Whether found or not, the current contact is added to the database, and the intelligent device searches for the next device that is proximate.

8. I am Looking For

The preference tables could be used to inform those proximate to the user that the user is looking for something, such as business contacts, friends, social contacts or relationships. This could be used as a type of dating application, or could be used to generate business contacts. At a trade show, say the Consumer Electronics Show, there are many attendees who have different interests. Say a user is interested in internet-of-things business contacts, setting that in his preferences would allow him to find others looking for IOT business contacts without having to talk with computer and TV vendors.

If the trade show app included a preference model, then a user could enter that he wanted to “talk to someone from NEC”. As he walked through the crowd, the app would scan the preference tables of those around him, and sound an alarm when someone from NEC is proximate. At that point, the app would show the persons picture, his name, title, etc, thus allowing the user to find the person and approach him to discuss business.

9. I am Selling or Looking to Buy

Many times people pass each other in the street even though one may have something for sale that another is looking to buy. We typically do not walk down the street with a sandwich board advertising that we are looking to sell our stereo. But with the computing power of modern intelligent devices searching the preferences of everyone we meet, an entry in the preference table listing the items we have for sale could be used to match up with another's preference table that states he is looking to buy. Therefore, by walking through a crowd with a preference table listing items for sale, a user could effectively find buyers with little effort. Once the preference table processing software detects a match between the available for sale preference table and the looking to buy tables, apps on the intelligent devices of the buyer and seller notify the users of a possible sale. Identifying information is then used to find locate the users who complete the sale.

10. I Want to Learn About or I am an Expert In

Similarly, preference tables could be used to match people looking to learn or teach subjects. At a university, one student could set their preference table to say that they are looking for assistance with Differential Equations, and another student may have set their preferences to state that they are looking to tutor someone in Differential Equations. As the students walk past each other in the student center, apps in both student's smart phones match them up, and notify each that there is someone near that can help. Identifying information is then used to allow the students to find each other.

In a trade show booth, an understanding of the crowd in the booth could be invaluable. It would allow the presenters to focus on the decision makers in the crowd, or to tailor the presentation to the interests of the crowd. If the crowd is interested in one product, the presenter could focus on that one and not spend time on other products, changing the demo on the fly. Or a voting algorithm preference model could be used to determine which demo is given. Give away trinkets could be saved for audiences of decision makers and restricted from those more interested in the trinket than the product. Coupons could be handed out for products that the audience is interested in.

11. Who I Am

The identifying information to allow the waitress, the tutor, or the buyer to find the user is useful to include in the preference table. This information may include the users name, a photo, voice print, descriptive information, a job title, company information, and other information that may be useful to establish a contact.

In one embodiment, the preferences are read by the venue through the preference model. With this, the photo is very important, as it allows a server to identify the specific customer once the BLE network has determined proximity. The photo could be displayed on a smart phone, a smart watch, on a Google Glass type device, on a teleprompter type device (imagine a glass window looking out at the customers entering a restaurant, with the waiter looking through the glass. Suddenly the preference system recognizes an approaching customer. The customer's photo appears on the glass, allowing the waiter to match the photo with the person walking in. The customer's name and preferences are also displayed. The waiter automatically orders the specific coffee for the customer, and moves to greet him by name). This model could be used on cruise ships, hotels, airlines, by politicians, by donor supported organizations and with concierges.

In another embodiment, an EMT could touch his phone to the phone of the person needing emergency care, and use the high RSSI similar to NFC to assure that the EMT is connected to the right phone. Then download photo, name, contact information and any medical information in the preference table to the responder to provide information to address the emergency.

D. Changing the Environment

There are a number of environmental parameters that can be set by using preferences either directly or through a negotiation process.

1. Temperature

Room temperature is one parameter that is desirable to set based on the preferences of those in the room. In addition, temperature of a pool or hot tub could be set via a preferences model. Since temperature takes time adjust, often the preferences are polled 10-15 minutes before the temperature is needed to allow for the area to come to temperature.

Temperature preferences could also be used to pre-warm or pre-cool a motor vehicle. It is envisioned that this may be a negotiated parameter as there may be an automatic negotiation between the preferences of the one paying for the fuel and the preferences of the one using the vehicle.

2. Music in the Room—Muzak Interface

Background music, sometimes referred to as Muzak, is an area subject to the personal preferences of those in the room or elevator (or other similar space). With music, there are so many choices that either a sharing algorithm or voting on general categories of music may be required.

3. TV Station in the Waiting Room

FIG. 1 shows an example of the preference file for setting the station or network on a television in a waiting room. Each user sends their preference to the TV that manages a negotiation to determine which station is selected.

In addition the use of closed caption messages on the TV screen could be determined by a preference scheme. Each user proximate to the television is polled for their preference table, and if any one of the preference tables contain a request for closed captioning, the TV displays the captions.

4. Noise Level of TV or Music

The volume of a television or of music in a space is often the subject of annoyance for people in the area. With a preference table, people can specify their preference for the volume of sound. Using a negotiation scheme, the optimal volume can be determined based on the preference tables.

5. Lighting—Brightness and Color

In addition to sound, the lighting of a space could be determined by the preference tables. At present, ilumi sells a color tunable LED light bulb that is controllable through a smartphone app. In utilizing a preference table, multiple people in a space illuminated by this light bulb could negotiate the color and intensity of the light in the space.

6. Art or Advertisements

The art on the wall of a home or in a gallery could be determined by negotiating the preferences of those proximate to the display. It is envisioned that the art could be presented using a type of computer display, perhaps using OLED, LED, LCD, Plasma, or CRT technologies. This concept could also be used for presenting advertisements as well. The display device could interrogate the preference table of those proximate to the device, and determine what the user would be interested in based upon the information in the preference table. Information on what the user is buying or selling could be used to display ads related to those items, or demographic information could be used to anticipate interests and influence the ads that are displayed.

7. Car or Room Color

There are several paint technologies that change the paint color or luminescence based on electricity or surrounding light that can be modified with a computer. These could also be modified using a preference table.

8. Parameters for Noise Canceling Headphones—Allowing Others to Talk Over

The parameters for noise canceling headphones could be adjusted based upon a preference table. For instance, the headphones could be set to cancel all outside noise, and a friend could approach the headphones and send a preference adjustment to allow human voices through the headphones, allowing the friend to talk to the headphone user.

9. Phone Behavior

A preference table could be used to modify the behavior of another's phone. For instance, parents may transmit a preference table to the children's cell phones during dinner to prevent any texts, phone calls, or emails from being received by the device until the meal is completed.

10. Elevator Floor

In another embodiment, an elevator could be set up to read the preference table of every occupant in the elevator. Assuming that most elevator riders travel between the same two floors (lobby and the location of their office or apartment, for instance), the elevator could collect preferences from everyone entering the elevator and then automatically set the floors to stop at without requiring the user to hit the button. Since everyone walks close to the elevator door on entering the elevator, this may be a good environment for NFC communication. In a hotel, the NFC could be used to read the floor from the room key. If the user enters the elevator at their floor, the elevator could assume that the destination is the lobby.

E. Phone Data

The preference table could also be populated with information from various sensors on the intelligent device. The temperature sensed at the intelligent device could be used by the HVAC system to adjust the temperature at the location of the people in the room, rather than the traditional sensing of the temperature at a fixed location where the thermostat is located.

Or the accelerometer data from the phone could be sent through the preference table to a car and used by the electronics in a car to determine how rough a ride the user is experiencing, and adjust the sensitivity of the shock absorbers or the speed to make the ride more enjoyable. Data from multiple users could be negotiated (combined) to determine the best parameters for all occupants.

Other sensors on the phone or other intelligent device could be incorporated into the preference table for other used. The location from the GPS is useful in many contexts, and a fitness monitoring intelligent device (Fitbit and the like) could create preference tables that transmit calories in and calories out, time spent exercising, and sleep statistics.

VII. Algorithm

FIG. 2 shows an algorithm for the implementation of a preferences scheme on an intelligent device. The algorithm starts with a search of the context for devices within the same context 201. The context concept is described in Section IV above and the methods for identifying devices is described in Section V above. Any of the concepts in these sections could be used to implement the Search described in 201. In one embodiment, each IP address available within the constraints of an IP mask are tested to see if a device is found 202. In another embodiment, a message is broadcast to all devices on the network and each response is processed. In still another embodiment, a trial message is sent to each possible address to see if a response is received. In another embodiment, the Bluetooth advertising mode and scanning states could be used to find proximate devices.

If the device is found, then the table of known IP address is searched to see if we already know about this device 203. If the device is known (“old”), the algorithm returns to 201 to look for the next address.

If the device is not known (“new”), the intelligent device's preference table is searched to see if there are any modifiers or special actions that need to be taken based on this address 204. This is an optional step. An example of this is the change of the ring tones on a phone based on the presence of a teacher. If the address of the teacher is found, the students ring tone in the preference table changes from Bob Marley to Bach. The outgoing preference table could also be modified to eliminate the request for a tutor should the student not want the teacher to know that he is seeking assistance with his schoolwork.

Once the preference table (or “profile”) is modified 204, the modified preference table is sent to the device that was found 205. Typically, the other device is also running through a similar algorithm and is sending out its preference table as well. If not, once the other device receives the preference table the device sends back its preference table.

The intelligent device receives the preference table from the found address 206 and parses the received preference table for information relevant to the intelligent device 207. Typically, a table such as in FIG. 3 is created to record the preferences from a number of devices. In some cases, a device may not send its preferences, either because it does not implement a preference scheme or because it is a read-only device (a thermostat, for instance). If no preference table is received from the device, the algorithm returns to 201 the search of the network.

Once we have updated the FIG. 3 table of preferences, the intelligent device performs a negotiation using one or more of the algorithms described in Section III above, and determines the parameter values to use.

The intelligent device then changes its behavior 221 based on the new parameters or the user is advised to change his behavior based on the new parameter. Then the intelligent device returns to its search for devices 201.

If the address is not found in 202, then the intelligent device checks to see if the address is known (“old”) 210. If the device is not known (“new”), then the algorithm returns to look for the next address. If the address is known (“old”), then it must be removed from having a voice in the negotiation. This may happen when someone leaves the context, such as the patient leaving the waiting room. In this case, we need to make sure that their choice for television station is no longer influencing the station choice.

To do this, we delete the preferences from the FIG. 3 table of preferences 211. Then we renegotiate the parameters using one of more of the techniques described in Section III.

Once the parameters are renegotiated 211, the behavior of the intelligent device and the user are modified 221 accordingly, and the algorithm returns to searching for devices 201.

This algorithm could be modified to perform the negotiation and/or behavior changes once for each pass through the context of addresses. The algorithm could be run continuously, or run once, or once in a period of time, or run based on an external event. Other changes could be made to this algorithm without departing from the spirit of the present invention.

VIII. Equipment

In one embodiment, the negotiation algorithms are executed in a device that is used to modify the environment. As has been described above, the device could be a thermostat or an audio-visual device such as a TV or a music playing device (stereo, iPad, AV system, Muzak system, automobile radio, etc). Each of these devices may have a processor for running the negotiation algorithm, the processor connected to a communications system that communicates to the preference devices using Bluetooth, Wi-Fi, cellular, NFC, or any other common communications protocol. The communication system could also be hardwired to Ethernet, USB or other protocols. The processor would also be connected to the real world through an output device, either directly or through another communications mechanism, that can turn on and off motors (in an HVAC system for example), adjust the volume on speakers (for TVs or stereos, etc.), change the channel on radios (for TVs or radio stations), so that the environment can be manipulated by the processor. The interface allows the processor to control the environment, such as changing the temperate by turning on or off an HVAC system, changing the volume on an AV system (or TV, etc.), changing the station on a TV (or the AV system), etc. The processor could be a separate device or it could be the main CPU for the controlled device.

The foregoing devices and operations, including their implementation, will be familiar to, and understood by, those having ordinary skill in the art. Particularly, a preference table should be construed to include a preference model, a preference template, a preference mold, a preference guide, a preference blueprint, a preference pattern, and the like.

The above description of the embodiments, alternative embodiments, and specific examples, are given by way of illustration and should not be viewed as limiting. Further, many changes and modifications within the scope of the present embodiments may be made without departing from the spirit thereof, and the present invention includes such changes and modifications.

1. A method for setting parameters of an environment management device comprising the steps of:
receiving a profile from each of two or more profile devices over a wireless network, the profile containing parameters related to the environmental management device;
executing a negotiation algorithm in the environment management device that selects a value to use to modify the environment based on the parameters received from the profile devices;
modifying the environment using the value determined by the negotiation algorithm; and
repeating the execution of the negotiation algorithm step and the modification of the environment step as a new profile is received.

2. The method for setting parameters of the environment management device of claim 1 wherein at least one of the profile devices is a smartphone.

3. The method for setting parameters of the environment management device of claim 1 wherein the environment management device is a smart thermostat.

4. The method for setting parameters of the environment management device of claim 1 wherein the environment management device is an audio-visual device.

5. The method for setting parameters of the environment management device of claim 4 wherein the parameter of the audio-visual device relates to either the volume or station.

6. The method for setting parameters of the environment management device of claim 1 wherein the negotiation algorithm is a voting algorithm.

7. The method for setting parameters of the environment management device of claim 1 wherein the negotiation algorithm is a bidding algorithm.

8. The method for setting parameters of the environment management device of claim 1 wherein the negotiation algorithm is a sharing algorithm.

9. The method for setting parameters of the environment management device of claim 1 wherein the negotiation algorithm is an averaging algorithm.

10. The method for setting parameters of the environment management device of claim 1 wherein the negotiation algorithm is a priority algorithm.

11. An environment management device comprising:
a processor,
a communications system connected to the processor,
an electrical interface connected to the processor, tied into an output device,
wherein the communication system receives profiles from a plurality of profile devices, and the processor periodically runs a negotiation algorithm using the profiles received from the profile devices to determine a value used to set parameters in the output device.

12. The environment management device of claim 11 wherein at least one of the profile devices is a smartphone.

13. The environment management device of claim 11 wherein the environment management device is a smart thermostat.

14. The environment management device of claim 11 wherein the environment management device is an audio-visual device.

15. The environment management device of claim 14 wherein the parameter of the audio-visual device relates to either the volume or station.

16. The environment management device of claim 11 wherein the negotiation algorithm is a voting algorithm.

17. The environment management device of claim 1 wherein the negotiation algorithm is a bidding algorithm.

18. The environment management device of claim 11 wherein the negotiation algorithm is a sharing algorithm.

19. The environment management device of claim 11 wherein the negotiation algorithm is an averaging algorithm.

20. The environment management device of claim 11 wherein the negotiation algorithm is a priority algorithm.
